(19) United States
(12) Patent Application Publication
(10) Pub. No.: US 2009/0286903 A1
(43) Pub. Date: Nov. 19, 2009

(54) ANTI-EFFLORESCENCE AGENT, USE IN A CEMENT MATRIX, MATRIX OBTAINED

(75) Inventors: Yves KENSICHER, Theize (FR); David Platel, Saint Maurice de Gourdans (FR); Robert Sobieski, Chester, NC (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: COATEX S.A.S, Genay (FR)

(21) Appl. No.: 12/464,948

(22) Filed: May 13, 2009

Related U.S. Application Data
(60) Provisional application No. 61/053,438, filed on May 15, 2008.

(30) Foreign Application Priority Data
May 14, 2008 (FR) 08 02602

(51) Int. Cl. C04B 24/26

(52) U.S. Cl. 524/5

(57) ABSTRACT

An anti-efflorescence agent, its use in a cement matrix, and the matrix obtained.

### REFERENCE TO PRIOR APPLICATIONS

This application claims priority to U.S. provisional application 61/053,438 filed May 15, 2008, and to French patent application 08 02602 filed May 14, 2008, both incorporated herein by reference.

### BRIEF DESCRIPTION OF THE INVENTION

The present invention relates to an acrylic dispersant anti-efflorescence agent, its use in a cement matrix, and the matrix obtained. In particular, the invention describes a composition and method for reducing the efflorescence phenomenon in concrete. In a preferred embodiment an anti-efflorescence agent is described comprising an aqueous solution of a hydrosoluble copolymer:
a) of acrylic acid, methacrylic acid and mixtures thereof, preferentially of methacrylic acid,
b) of styrene, alpha-methyl styrene, vinyl toluene and mixtures thereof, preferentially of styrene,
c) and of an alkyl acrylate or alkyl methacrylate, the alkyl group having from 1 to 4 carbon atoms, preferentially of an alkyl acrylate, very preferentially of butyl acrylate.

Additional aspects and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Efflorescence is a natural phenomenon that results from the hydration of cement, a component of concrete: this hydration leads to the solubilization of certain mineral species such as, in particular, lime, that then migrate to the surface of the concrete. Then, the formation of particularly unsightly white spots is seen.

Usually, primary efflorescence, the result of drying of the concrete where salts come back up to the surface by capillary migration, is distinguished from secondary efflorescence that may occur later on, when runoff waters penetrate to the interior of the concrete matrix, extract the soluble salts, and cause them to come back up to the surface by capillary action. Of course, it is far more difficult to combat the second type of efflorescence that can occur later on than primary efflorescence, the latter occurring only in the first hours of drying of the concrete. This efflorescence phenomenon generally can be seen in any composition based on hydraulic binders and based on calcium sulfate or derivatives thereof.

For a very long time those of ordinary skill in the art have been seeking solutions to combat this phenomenon that creates problems of discoloration, whether this is linked to primary or secondary efflorescence. The oldest technique is connected with the incorporation of hydrophobic compounds into the concrete matrix. The matrix having dried, these compounds act as a barrier against runoff water, and therefore are going to counter secondary efflorescence. These hydrophobic substances generally are silicones (see documents JP 10036708, JP 4074779) or fatty acids, the most commonly used being zinc, sodium, but especially calcium stearates (see documents EP 1 547 987, U.S. Pat. No. 5,460,648, JP 64003041, CA 2 246 930, CA 2 287 664). These substances, however, prove to be active only after drying of the concrete, and are not able to effectively combat primary efflorescence.

Another technique is connected with the use of latexes, which initially were applied as a paint even prior to drying of the concrete, with a view to creating an impermeable film on the surface thereof: in that way, migration of the soluble salts during the stage of drying of the concrete is avoided, and subsequent penetration of the runoff waters is prevented. On this subject, reference may be made to documents DE 4 342 260 and U.S. Pat. No. 5,215,827. Later, it was thought to incorporate the latexes within the concrete matrix: this is, in particular, the object of document EP 0 970 931, for just as comparable results.

It is recalled that latexes designate macromolecular compounds (with very high molecular weights, typically in excess of 1,000,000 g/mole) and which by nature remain insoluble in water. They result from the polymerization or from the copolymerization of several monomers, generally chosen from among the carboxylic monomers such as acrylic, methacrylic, maleic acids, or from among the esters of these acids, or acrylamide, or from among the vinyl monomers such as vinyl chloride. The most used copolymers are based on styrene-acrylic, styrene-butadiene, or even vinyl-ethylene acetate.

Thus document EP 0 970 931 indicates that the additive used is a latex in emulsion, or in the form of powder [0022], which clearly distinguishes it from those used in this invention. This document cites as examples commercial products that are latexes sold under the names Acronal™ S400 (BASF™), Dow™ 460 (DOW™ CHEMICALS), Rhopex™ E300 (ROHM & HAAS™), or Ucar™ Latex 417 (UNION CARBIDE™).

Likewise, document U.S. Pat. No. 5,922,124 describes the use of a hydrophobic compound and of a polymer in the form of solid particles as an anti-efflorescence agent. The polymer may be an acrylic latex (claim 87). Furthermore, this document provides for the addition of other additives, including a dispersant, in the cement matrix (claim 52). The polymer that is the object of this invention is in the form of an aqueous solution, and not of insoluble particles.

Document U.S. Pat. No. 6,537,366 describes a non-efflorescent concrete composition containing a coloring agent, a hydrophobing agent and a copolymer in the form of particles that may be of styrene-acrylic nature (claim 9). This polymer is on the one hand in particle form, and does not act as a dispersant, since it is necessary to add an agent making it possible to disperse the mineral material in the matrix (column 7, lines 55-60).

Finally, document WO 06 094528 describes non-efflorescent cement compositions which contain, among other things, a copolymer that may be of styrene-acrylic origin. This document emphasizes the presence of an acrylic or phosphatic dispersant agent (page 6, lines 28-30).

In addition to the use of hydrophobic compounds, or of polymers in the form of latex applied to the surface of the concrete or incorporated in the course of its manufacture, those of ordinary skill in the art have investigated a third option for reducing the efflorescence phenomenon: the use of agents for modifying the viscosity of the medium. First they had recourse to dispersants, the function of which is to lower viscosity, to accomplish the dispersion of mineral particles in the concrete, and thus to facilitate the operation of mixing of the different components: in this way there is obtained a better dispersed matrix, which reduces the capillary phenomena and therefore the efflorescence.

But it was seen that the dispersant action was prolonged over time. Even though the capillary action is reduced by the use of this additive, the latter subsequently is going to behave as a dispersant with regard to the saline waters contained in the concrete: the latter then migrate more easily to the surface, even though the capillary networks are less numerous and narrower. This phenomenon is described very precisely in document CA 2 444 908 (top of page 4): it sets up a very strong prejudice against the use of dispersants, in order to avoid or reduce the efflorescence phenomenon.

Subsequently, those of ordinary skill in the art took an interest in other agents capable of modifying the viscosity: the thickeners which, as their name indicates, have the function of increasing the viscosity of the medium. This is the object of document CA 2 444 908 cited above: this Theological agent makes it possible to thicken the aqueous phase contained within the concrete. Since the aqueous phase is thickened, it shifts less easily by capillary action: the soluble salts that it contains migrate less readily to the surface.

This mechanism was taken up in document US 2006 054056, through the use, in a cement matrix, of a thickener also described as an absorbent or super-absorbent agent, the preferential version of which consists of a soluble and cross-linked alkali polyacrylate.

This being the case, it is well known that numerous additives referred to as anti-efflorescent agents contribute in a harmful manner to the rheological properties of the concrete matrices into which they are incorporated: this negative impact is particularly obvious on the compressive strength measured at 28 days (this date typically corresponding to the possible appearance of spots on the surface, linked to secondary efflorescence).

### DETAILED DESCRIPTION OF THE PREFERRED EMBODIMENTS

Seeking to enrich the state of the art through a new solution making it possible to reduce the efflorescence phenomenon in concrete, preferably including both primary and secondary efflorescence, while not degrading the rheological properties of the concrete, such as its compressive strength at 28 days, the present inventors have discovered the use, as an anti-efflorescence agent, of an aqueous solution of a hydrosoluble copolymer comprising, consisting of, and consisting essentially of at least one monomer from each of the following a), b) and c) in polymerized form:
a) acrylic acid, methacrylic acid and mixtures thereof, preferentially methacrylic acid,
b) styrene, alpha-methyl styrene, vinyl toluene and mixtures thereof, preferentially styrene,
c) and a C₁₋₄ alkyl acrylate or C₁₋₄ alkyl methacrylate, the alkyl group having from 1 to 4 carbon atoms, preferentially a C₁₋₄ alkyl acrylate, very preferentially butyl acrylate.

In an entirely unexpected way, it turned out that these copolymers, when used in concrete compositions, reduce the efflorescence phenomenon in a noteworthy manner, in comparison with the same composition not containing them. In addition, the anti-efflorescent effect is seen for a considerably smaller quantity than that for calcium stearate used in a comparative test; finally, this nevertheless smaller quantity of agent according to the invention makes it possible to obtain a compressive strength at 28 days much better than for a greater proportion of calcium stearate. With a quantity of product lesser than that of calcium stearate, a better rheological/esthetic appearance compromise is obtained in entirely advantageous manner.

These results are all the more surprising since the copolymer according to the invention is known, in another activity sector, for being a dispersant agent for mineral materials particularly effective with a view to formulating a paint (see document EP 0 737 728, incorporated herein by reference) as there existed in the state of the art (in particular in the recent document CA 2 444 908 published in May 2005) a very strong prejudice concerning the use of dispersants in order to combat efflorescence.

One object of the invention is an anti-efflorescence agent for a cement matrix comprising an aqueous solution of a hydrosoluble copolymer comprising, consisting of, and consisting essentially of at least one monomer from each of monomers a), b) and c) in polymerized form:
a) acrylic acid, methacrylic acid and mixtures thereof, preferentially methacrylic acid,
b) styrene, alpha-methyl styrene, vinyl toluene and mixtures thereof, preferentially styrene,
c) and a C₁₋₄ alkyl acrylate, a C₁₋₄ alkyl methacrylate, and mixtures thereof, the alkyl group having from 1 to 4 carbon atoms, preferentially a C₁₋₄ alkyl acrylate, very preferentially butyl acrylate.

Preferably, monomers a), b) and c) are present in the following amounts by weight based on total weight of copolymer:
a) 40% to 60%,
b) 25% to 45%,
c) of 5% to 20%

Preferably, the copolymer comprises no monomers other than a), b) and c) above such that the sum of the percentages of a), b), and c) are equal to 100%.

Preferably, the amount of hydrosoluble copolymer in the invention aqueous solution is 1-99% (weight of copolymer/total weight of aqueous solution), more preferably 5-65% even more preferably 10-40%, including 3, 7, 10, 15, 20, 25, 30, 35, 45, 50, 55, 60, 70, 75, 80, 85, 90 and 95% including all subranges and values between stated values.

Preferably, the invention hydrosoluble copolymer has a molecular weight of 5,000 g/mole to 80,000 g/mole, preferentially 5,000 g/mole to 50,000 g/mole, very preferentially 5,000 g/mole to 30,000 g/mole, including 10,000, 15,000, 20,000, 25,000, 35,000, 40,000, 45,000, 55,000, 60,000, 65,000, 70,000 and 75,000 g/mole including all subranges and values between stated values. These values are preferably determined by gas phase chromatography. These values are preferably expressed as weight average molecular weights, or M_{w}.

Another object of the invention is a cement matrix comprising an aqueous solution of at least one invention hydrosoluble copolymer described above. These cement matrices preferably comprise from 0.1% to 1.5% by weight of the aqueous solution of the hydrosoluble copolymer, in relation to the dry weight of cement. These amounts are not limiting, however, and the amount may range up to 30% and greater, including for example 2, 4, 6, 8, 10, 15, 20, 40, 50, 60, 70, 80, etc. % in relation to the dry weight of cement, including all subranges and values between stated values.

The invention cement matrices preferably comprise from 0.001-10%, including 0.005, 0.01, 0.015, 0.02, 0.03, 0.04, 0.05, 0.08, 0.1, 0.15, 0.2, 0.3, 0.5, 0.8, 1, 1.5, 2, 3, 4, 5, 6, 7, 8, and 9% including all subranges and values between stated values, by weight of the hydrosoluble copolymer, in relation to the dry weight of all components in the cement matrix. These amounts are not limiting, however, and the amount may range up to 50% and greater, including 15, 20, 30, 40, 60, 70, 80, etc. % for example in relation to the dry weight of all components in the cement matrix, including all subranges and values between stated values.

The aqueous solution of the at least one invention hydrosoluble copolymer preferably comprises from 0.1% to 75% by weight of the at least one hydrosoluble copolymer, in relation to the total weight of aqueous solution. These amounts are not limiting, however, and the amount may range up to 90% and greater, including for example 1, 2, 4, 6, 8, 10, 15, 20, 30 40, 50, 60, 70, 80, etc. % in relation to the total weight of aqueous solution, including all subranges and values between stated values.

The aqueous solution of the at least one invention hydrosoluble copolymer preferably comprises from 0.1% to 75% by weight of water, in relation to the total weight of aqueous solution. These amounts are not limiting, however, and the amount may range up to 99% and greater, including for example 1, 2, 4, 6, 8, 10, 15, 20, 30 40, 50, 60, 70, 80, 90, 95, 97% etc. % in relation to the total weight of aqueous solution, including all subranges and values between stated values.

Preferably the cement matrix is one based on hydraulic binders and is chosen from a concrete or a mortar. Cement matrices on the basis of calcium sulfate or derivatives thereof may also preferentially be used.

The matrices described herein can be prepared by mixing the above-described aqueous solution with, e.g., cement and any other optional ingredient in the matrix, followed by, e.g., normal drying or curing, etc.

### EXAMPLES

4 identical formulations of concrete, according to the methods well known to those of ordinary skill in the art, are made up of:
253.5 parts by weight of an aggregate referenced as A
404.7 parts by weight of an aggregate referenced as B
186.8 parts by weight of an aggregate referenced as C
50 parts by weight of clinker marketed under the name Mesacrete,
105 parts by weight of Portland cement.

The final formulation furthermore contains 6% by weight of water, this water having been provided both by the different components used, and to adjust the rheology of his formulation.

The granulometric characteristics of sands A, B and C are given in Table 1, which indicates the % by weight of the particles having passed through a sieve with a given diameter d in mm:

TABLE 1

| | d (mm) | | | | | | |
|---|---|---|---|---|---|---|---|
| | 4.76 | 2.38 | 1.19 | 0.595 | 0.297 | 0.149 | <0.149 |
| Sand A | 100.00% | 96.58% | 78.34% | 65.23% | 53.25% | 23.61% | 4.80% |
| Sand B | 100.00% | 99.37% | 87.34% | 69.62% | 49.37% | 15.19% | 2.53% |
| Sand C | 100.00% | 95.62% | 27.12% | 4.10% | 1.37% | 0.82% | 0.55% |

In these 4 formulations there are incorporated by simple mixing:
0.3% by weight, as is, of an aqueous dispersion containing 24% by dry weight of calcium stearate, according to the prior art for test No. 1, in relation to the weight of Portland cement only

or
0.1%, 0.2%, and 0.3% of an aqueous solution containing 24% by dry weight of a copolymer according to the invention, for tests No. 2, 3 and 4 respectively, in relation to the weight of Portland cement

The copolymer is made up, expressed in % by weight of each of its monomers, of:
a) 50.0% by weight of methacrylic acid,
b) 36.3% by weight of styrene,
c) 13.7% by weight of butyl acrylate.

For each of these formulations 1 to 4, there are determined:
the compressive strength at 28 days, according to ASTM standard C-140 section 6.2.6 (the standard indicating 3,000 PSI as being the minimal desirable value).
the efflorescence at 28 days, according to ASTM standard C-67 section 11.

The results appear in Table 2.

TABLE 2

| | Comparison | | | | |
|---|---|---|---|---|---|
| | (C) or | | | | Compression |
| | Invention | | | Efflorescence | 28 days |
| test | (IN) | additive | quantity | 28 days | (PSI) |
| 1 | C | Ca St | 0.3 | No | 2870 |
| 2 | IN | Copolymer | 0.1 | No | 3180 |
| 3 | IN | Copolymer | 0.2 | No | 3340 |
| 4 | IN | Copolymer | 0.3 | No | 3570 |

Ca St designates the calcium stearate
Copolymer designates the copolymer according to the invention described above

Table 2 demonstrates that only the copolymer corresponding to the invention make it possible to obtain the desired compromise between an absence of efflorescence and a compressive strength in excess of 3000 PSI, all at 28 days. Furthermore, this compromise is achieved for a considerably smaller quantity of additive according to the invention (compare test No. 1 with test No. 2). For test No. 4, which uses an identical quantity of the copolymer of the invention, relative to test No. 1 using calcium stearate, an even more marked effect is obtained: the efflorescence phenomenon is still absent, while the compressive strength has been increased by more than 20%.

The above written description of the invention provides a manner and process of making and using it such that any person skilled in this art is enabled to make and use the same, this enablement being provided in particular for the subject matter of the appended claims, which make up a part of the original description and including the use, as an anti-efflorescence agent for a matrix based on a hydraulic binder or based on calcium sulfate or derivatives thereof, of an aqueous solution of a hydrosoluble copolymer comprising, consisting or, and consisting essentially of a), b) and c):
a) acrylic acid, methacrylic acid and mixtures thereof, preferentially methacrylic acid,
b) styrene, alpha-methyl styrene, vinyl toluene and mixtures thereof, preferentially styrene,
c) and a C₁₋₄ alkyl acrylate, a C₁₋₄ alkyl methacrylate, and mixtures thereof, the alkyl group having from 1 to 4 carbon atoms, preferentially a C₁₋₄ alkyl acrylate, very preferentially butyl acrylate.

As used herein, the phrases “selected from the group consisting of,” “chosen from,” and the like include mixtures of the specified materials. Terms such as “contain(s)” and the like when used herein are open terms meaning ‘including at least’ unless otherwise specifically noted. Phrases such as “mention may be made,” etc. preface examples of materials that can be used and do not limit the invention to the specific materials, etc., listed. As used herein, the words “a” and “an” and the like carry the meaning of “one or more.”

All references, patents, applications, tests, standards, documents, publications, brochures, texts, articles, etc. mentioned herein are incorporated herein by reference.

Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A method, comprising mixing an anti-efflorescence agent and a cement composition, wherein the anti-efflorescence agent comprises an aqueous solution comprising water and a hydrosoluble copolymer, the hydrosoluble copolymer comprising at least one monomer from each of a), b) and c) in polymerized form:
a) acrylic acid, methacrylic acid and mixtures thereof;
b) styrene, alpha-methyl styrene, vinyl toluene and mixtures thereof;
c) a C₁₋₄ alkyl acrylate, a C₁₋₄ alkyl methacrylate, and mixtures thereof.

2. The method according to claim 1, wherein the hydrosoluble copolymer comprises a monomer from each of a), b) and c) in polymerized form:
a) methacrylic acid
b) preferentially styrene
c) butyl acrylate.

3. The method according to claim 1, wherein the hydrosoluble copolymer comprises monomers a), b) and c) in the following amounts by weight based on total weight of copolymer:
a) 40% to 60%,
b) 25% to 45%,
c) of 5% to 20%.

4. The method according to claim 1, wherein the hydrosoluble copolymer consists of monomers a), b) and c).

5. The method according to claim 2, wherein the hydrosoluble copolymer consists of monomers a), b) and c).

6. The method according to claim 1, wherein the hydrosoluble copolymer has a M_{w} of 5,000-80,000 g/mole.

7. The method according to claim 1, wherein the cement composition is a concrete or a mortar.

8. A composition comprising an anti-efflorescence agent and cement, wherein the anti-efflorescence agent comprises an aqueous solution comprising water and a hydrosoluble copolymer, the hydrosoluble copolymer comprising at least one monomer from each of a), b) and c) in polymerized form:
a) acrylic acid, methacrylic acid and mixtures thereof;
b) styrene, alpha-methyl styrene, vinyl toluene and mixtures thereof;
c) a C₁₋₄ alkyl acrylate, a C₁₋₄ alkyl methacrylate, and mixtures thereof.

9. The composition according to claim 8, wherein the hydrosoluble copolymer comprises a monomer from each of a), b) and c) in polymerized form:
a) methacrylic acid
b) preferentially styrene
c) butyl acrylate.

10. The composition according to claim 8, wherein the hydrosoluble copolymer comprises monomers a), b) and c) in the following amounts by weight based on total weight of copolymer:
a) 40% to 60%,
b) 25% to 45%,
c) of 5% to 20%.

11. The composition according to claim 8, wherein the hydrosoluble copolymer consists of monomers a), b) and c).

12. The composition according to claim 9, wherein the hydrosoluble copolymer consists of monomers a), b) and c).

13. The composition according to claim 1, wherein the hydrosoluble copolymer has a M_{w} of 5,000-80,000 g/mole.

14. A composition comprising an anti-efflorescence agent and cement, wherein the anti-efflorescence agent comprises a hydrosoluble copolymer comprising at least one monomer from each of a), b) and c) in polymerized form:
a) acrylic acid, methacrylic acid and mixtures thereof;
b) styrene, alpha-methyl styrene, vinyl toluene and mixtures thereof;
c) a C₁₋₄ alkyl acrylate, a C₁₋₄ alkyl methacrylate, and mixtures thereof.

15. The composition according to claim 14, wherein the hydrosoluble copolymer comprises a monomer from each of a), b) and c) in polymerized form:
a) methacrylic acid
b) preferentially styrene
c) butyl acrylate.

16. The composition according to claim 14, wherein the hydrosoluble copolymer comprises monomers a), b) and c) in the following amounts by weight based on total weight of copolymer:
a) 40% to 60%,
b) 25% to 45%,
c) of 5% to 20%.

17. The composition according to claim 14, wherein the hydrosoluble copolymer consists of monomers a), b) and c).

18. The composition according to claim 15, wherein the hydrosoluble copolymer consists of monomers a), b) and c).

19. The composition according to claim 14, wherein the hydrosoluble copolymer has a M_{w} of 5,000-80,000 g/mole.

20. A method for preparing the composition according to claim 14, comprising mixing an aqueous solution comprising water and at least one hydrosoluble copolymer with cement, wherein the hydrosoluble copolymer comprises at least one monomer from each of a), b) and c) in polymerized form:
a) acrylic acid, methacrylic acid and mixtures thereof;
b) styrene, alpha-methyl styrene, vinyl toluene and mixtures thereof;
c) a C₁₋₄ alkyl acrylate, a C₁₋₄ alkyl methacrylate, and mixtures thereof.
